(19) United States
(12) Patent Application Publication
(10) Pub. No.: US 2015/0041174 A1
(43) Pub. Date: Feb. 12, 2015

(54) CABLE TERMINATION DEVICE

(71) Applicant: PHOENIX CONTACT GMBH & CO. KG, Blomberg (DE)

(72) Inventor: Jens Franke, Bad Pyrmont (DE)

(21) Appl. No.: 14/386,346

(22) PCT Filed: Mar. 5, 2013
(86) PCT No.: PCT/EP2013/000646

§ 371 Date: Sep. 19, 2014

(30) Foreign Application Priority Data
Mar. 21, 2012 (DE) 10 2012 005 545.5

(51) Int. Cl. H02G 15/04

(52) U.S. Cl. CPC H02G 15/043
USPC 174/82

(57) ABSTRACT

A cable termination device includes a housing further including a termination cap, a screw unit and an insertion opening for cable in order to terminate the cable end in an electrical-shock-proof manner. The termination cap interacts with the screw unit. The insertion opening is provided in the screw unit and has at least one core. At least one elongate receiving pocket is provided in the housing to receive at least one core.

### CROSS REFERENCE TO RELATED APPLICATIONS

This application is a U.S. National Phase application under 35 U.S.C. §371 of International Application No. PCT/EP2013/000646 filed on Mar. 5, 2013, and claims benefit to German Patent Application No. DE 10 2012 005 545.5, filed on Mar. 21, 2013. The International Application was published in German on Sep. 26, 2013, as WO 2013/139436 under PCT Article 21(2).

### FIELD

The present invention relates to a cable termination device which is provided and suitable for terminating at least one cable end in an electric-shock-proof manner.

### BACKGROUND

A cable end that is sealed from environmental influences such as dust and water is frequently needed in the assembly of photovoltaic systems, for example. Such cable termination devices should generally meet at least protection class IP 67 in accordance with DIN EN 60529 and/or DIN 40050 Part 9. That means that the cable termination device is constructed such that it is dustproof and at least provides protection against intermittent submersion of the cable termination device in water, since such conditions may occur when cables are laid outdoors, for example when used in photovoltaic systems. Apart from their use in photovoltaic systems, the use of the cable termination device according to the invention is also possible on other electrical or electronic components.

To simplify the assembly of photovoltaic systems, the power cables can be manufactured for example with T-pieces directly on the reel at regular intervals in order to make it easier to assemble and connect solar modules later. Then such a cable has for example T-pieces at pre-determined intervals such as 1 m or similar to connect solar modules. In order to assemble solar modules it is then simply necessary to unroll the desired length of solar cable from the reel and cut it to the desired length. During the subsequent assembly the solar modules can then be connected laterally to the T-pieces that have already been provided. However, it is important for the free end of the solar cable that has been cut to be terminated reliably. Due to the potentially high current strengths and voltages in photovoltaic systems it is important for the power cables to be durably reliably terminated and in an electric-shock-proof manner.

Because with the increasing installation of photovoltaic systems on private individuals' roofs inexperienced people are increasingly gaining access to such electrical systems, it is important to terminate such solar cables such that the inhabitants or owners of a house equipped with a photovoltaic system are exposed to as little danger as possible.

The unpublished DE 10 2010 047 217 describes a cable termination device for the termination of cable ends, it no longer being possible to open the cable termination device by hand following completion of the assembly. Such a cable termination device facilitates reliable operation. Depending on the purpose and the intended operating voltage which cables to be connected and terminated can have, it can, however, be favourable or necessary to provide larger air gaps and creepage paths between the ends of the cores of a cable end to be terminated.

### SUMMARY

In an embodiment, the present invention provides a cable termination device including a housing having a termination cap, a screw unit and an insertion opening for cable having at least one core in order to terminate a cable end in an electrical-shock-proof manner. The termination cap interacts with the screw unit. The insertion opening is provided in the screw unit. At least one elongate receiving pocket is provided in the housing to receive the at least one core.

### BRIEF DESCRIPTION OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 is a view of a cable termination device according to the invention;

FIG. 2 is an exploded view of the cable termination device according to FIG. 1;

FIG. 3 is a perspective plan view onto the screw part of the cable termination device according to FIG. 1;

FIG. 4 is a perspective plan view onto the termination cap of the cable termination device according to FIG. 1;

FIG. 5 is a perspective view of the termination cap according to FIG. 1 from below;

FIG. 6 is a cross section through the termination cap according to FIG. 4;

FIG. 7 is a cross section through the cable termination device according to FIG. 1;

FIG. 8 is an exploded view of the cable termination devices according to FIG. 7; and

FIG. 9 shows the cable termination device being assembled with a tool.

### DETAILED DESCRIPTION OF THE INVENTION

An aspect of the present invention provides a cable termination device which facilitates larger air gaps and creepage paths and is simple to assemble.

The cable termination device according to the invention has a housing with at least one insertion opening for a cable with at least one core, in order to terminate the cable end in an electric-shock-proof manner. The housing comprises a termination cap and a screw unit, which interacts with said termination cap, the insertion opening for receiving the cable end being provided in the screw unit. At least one elongate receiving pocket is provided in the housing to receive the at least one core.

The cable termination device according to the invention has many advantages because it provides simple assembly and a high degree of safety.

Preferably, two or more receiving pockets are provided. The at least two receiving pockets serve to receive separately from one another at least two cores of a cable to be connected. If only one receiving pocket is provided for a single core, then the cable termination device ensures protection from electric shocks and protection from environmental influences.

Furthermore, a considerable advantage of a cable termination device according to the invention is that greater air gaps and creepage paths between, for example, individual cores of a cable to be terminated are facilitated. During assembly, the cores are inserted into individual receiving pockets and thus separated from one another efficiently and effectively. The size of an air gap and creepage path can be easily adjusted by, for example, the length of the receiving pockets. The minimal air gap and creepage path results from double the length of one receiving pocket in the case of two adjacent receiving pockets. In principle, the receiving pockets can be of any length such that any air gaps and creepage paths can be ensured in principle. At the same time simple assembly is facilitated.

The at least one receiving pocket can be provided on an insert, which is received at least in part inside the termination cap. Using this type of configuration, such termination caps can also optionally be assembled on cable termination devices according to the prior art described above. Such a configuration facilitates a particularly flexible application and the use of the termination caps not only on a cable termination device according to the invention.

Preferably, the at least one receiving pocket is formed in the termination cap. This means that the termination cap can be formed in one piece and that the at least one receiving pocket is provided therein. For example, such a termination cap can be produced as an injection moulded part, which facilitates cost-effective production in high quantities. Another considerable advantage of a termination cap with a receiving pocket formed therein is that assembly is simplified.

In the case of such a configuration it is possible for the cable termination device to essentially consist of just two parts, namely the termination cap and the screw unit that interacts with said termination cap. In addition, a seal can also be provided between the termination cap and the screw unit.

In principle, the cable termination device can be pre-assembled in the case of such a configuration such that the cable with one core or individual cores only has to be slid into the cable termination device in order to terminate a cable to be terminated. Subsequently, the screw unit can be screwed to the termination cap such that the at least one core end of the cable end is not only received in an electric-shock-proof manner but also held in the cable device such that it cannot be pulled out.

In all of the configurations it is particularly preferable for at least one receiving pocket to be formed as a blind hole. In particular, all of the receiving pockets are constructed as blind holes. Such a blind hole preferably has a wall over the entire circumference at least along a substantial part of its length and is closed at the end. It is also possible for the end of the blind holes to be closed separately using a plug or adhesive substance or similar.

It is particularly preferable for the length of at least one receiving pocket and in particular of all of the receiving pockets to be at least 2 mm or 2.5 mm or more. The length of at least one receiving pocket can also be, or exceed, 5 mm or 10 mm. Lengths of 15 mm or even significantly more are also possible. The air gap and creepage path can thus be predetermined by the length of the receiving pocket. The dimensions of the cable termination device can thus be adjusted to the respectively intended operating conditions. Therefore longer or shorter receiving pockets are possible.

In all of the embodiments a length of at least one receiving pocket can be at least twice as great or even four times as great as a diameter of the receiving pocket.

Preferably at least one insertion aid is assigned to at least one receiving pocket. Such an insertion aid makes the insertion of a core into a receiving pocket easier. The insertion aid can, for example, comprise an insertion chamfer or be constructed as such. It is also possible and preferable for the insertion aid to be constructed as an insertion funnel. A funnel or a chamfer on the receiving opening of the receiving pocket allows for more reliable and simpler operation. Because a core to be inserted is automatically directed into the receiving pocket by the insertion aid, incorrect assembly can be prevented and assembly generally made easier.

The insertion aid can be provided on a separate component. It is also possible for the insertion aid to be formed integrally with the receiving pocket.

Preferably, at least one latching device is provided for the purpose of latching the screw unit to the termination cap.

In preferred developments the latching device comprises at least one latch toothing and at least one latch element interacting therewith. The use of a latching device with a latch toothing and at least one latch element interacting therewith facilitates a reliable latching of the cable termination device.

The latch toothing can be constructed as an axial toothing and interact with a corresponding latching element which acts axially.

It is particularly preferable for a radially acting latch toothing to be provided, which is arranged radially on the housing. Preferably at least one in particular resiliently acting latching element is then provided on the termination cap. In all cases it is particularly preferable for a plurality of latching elements to be provided, which are distributed in particular symmetrically over the circumference.

In advantageous configurations the latching device comprises at least one helical toothing. The helical toothing has teeth, one edge of which is constructed such that it is considerably shallower than the other edge. It is also possible for one edge to be constructed such that it is shallow and the other edge is orientated perpendicularly at an angle of 90° for example. It is also possible for a gradient of the edge to be greater than 90°, resulting in a projection or indentation on this tooth edge. Such configurations facilitate a connection that is particularly difficult to release.

In principle, latching devices with latch toothings where there is a particularly steep tooth edge for latching can only be released using a lot of force. It is particularly preferable here for such a large amount of force to be selected that without the use of a tool a release of the connection would only be possible by destroying the latching device and thus the terminating device altogether.

In particularly preferable configurations the helical toothing is engaged with the latching element at least temporarily and/or at least in portions during the screwing process. In the process the teeth of the helical toothing slope upwards at a lower gradient in the direction of screwing than in the opposite direction. A simple screwing of the termination cap to the housing is thus possible. The latching element and/or teeth of the helical toothing yield resiliently during the screwing process. Once the termination cap has been successfully screwed in or on, the steeper progression of the teeth of the helical toothing on the other side means that it is only possible to unscrew it using a lot of force, which generally leads to destruction of the component.

In preferred configurations the latch toothing is arranged radially on the exterior of the housing. It is, however, also possible for the latch toothing to be provided radially on the interior along a circumferential contour or a circumferential shoulder. The at least one latching element is accordingly provided either radially on the exterior or radially on the interior in order to ensure engagement with the latch toothing.

If the termination cap is constructed such that it is rounded on the outermost end then this allows even more reliable and durable protection from accidental or unintentional opening of the cable termination device as a result of the shape of the termination cap even if the typically plastics housing parts such as the termination cap and screw unit should be subject to settlement.

In a preferred development a locking device, which may in particular be gripped by a tool, is provided on the outer end of the termination cap. A locking device on the outer end of the termination cap offers the advantage that the termination cap can be held by a tool, which has gripped the locking device, while the screw unit is screwed. When the screwing process is complete the tool can be removed so that it is not possible to re-open it subsequently without a tool.

Preferably, the locking device comprises at least one slit and/or a through-hole, which extends transverse to the longitudinal extension of a cable that is to be terminated. A tool such as a screwdriver may, for example, be inserted through a through-hole and thus used to fix the position. The screw unit can be rotated towards the termination cap, which is fixed in place, in order to close the housing of the cable termination device and terminate the cable accommodated therein in an electric-shock-proof manner.

Preferably, the termination cap on the outer end is constructed such that it is approximately spherical. Such a spherical configuration offers advantages since the fixing of the spherical end of the termination cap by hand is only possible with great difficulty. An accidental opening of the cable termination device is therefore practically impossible.

The termination cap preferably has an external thread along at least one longitudinal portion. In particular the screw unit has an internal thread along at least one longitudinal region. It is particularly preferable for the internal thread of the screw unit to interact with the external thread of the termination cap in order to screw the housing of the cable termination device together.

The screw unit can have at least one sealing cone, which compresses a lamella structure when the screw unit is screwed to the termination cap such that the sealing unit is pressed against an inserted cable end inside the screw unit and the cable end is thus protected from the ingress of water and dust and suchlike.

In all of the configurations it is preferable for at least 3, 4, 5 or 6 or more receiving pockets to be provided.

It is particularly preferable for an angle between the longitudinal axis of the housing and a longitudinal axis of at least one receiving pocket to be less than 30°. In particular the angle is less than 15°. In preferred configurations a longitudinal axis of the receiving pocket and a longitudinal axis of a cable to be inserted extend substantially in the same direction. The longitudinal axis of the receiving pocket can be roughly parallel to the longitudinal axis of the housing. This facilitates a compact cable termination device which has a small outer diameter. Each core can be bent over a short distance to an angle that is greater than 15°, 30° or 45° or more. The angle between the longitudinal axis of the housing and a longitudinal axis of at least one receiving pocket defines the alignment of the longitudinal axes to one another and not possible deflection angles over short distances.

In principle, any deflection angle is possible over short distances. In particular configurations a maximum deflection angle is provided which is less than 75° or 60° or even 45° over a short distance of at least one core end of the cable end. A short distance can be understood, for example, to be four times the diameter of a core.

It is possible for the cable termination device to be used in a pre-assembled manner. A portion of the sheath of the cable, the length of which is roughly equivalent to the length of the receiving pocket or is slightly greater or slightly shorter, can then be removed for assembly. Subsequently, the cable end with its individual cores is inserted into the insertion opening until the individual cores reach the insertion openings of the receiving pockets. The threading of the individual cores into the individual receiving pockets is facilitated by means of slight rotational movements of the cable in relation to the housing or by means of slight rotational movements of the housing in relation to the cable. After the individual cores have been pushed forward to the ends of the receiving pockets and are, for example, abutting them, the housing can be screwed together. For this purpose the termination cap can be held so that it cannot rotate, using a tool for example, while the screw part is screwed to the termination cap. During the screwing process, a sealing unit provided inside the screw part is clamped against the cable thus ensuring an electric-shock-proof termination of the cable end such that it cannot be pulled out. This method is also possible in exactly the same way if only one single receiving pocket is provided to receive a single core.

It is possible for a portion of the sheath of the cable, the length of which is slightly shorter than the length of the receiving pocket, to be removed for assembly. This will occur more frequently in practice since the core will not necessarily always be cut to exactly the precise length. Therefore it is often better to cut the core so that it is slightly shorter rather than too long. This will be taken into account in the dimensioning of the air gaps and creepage paths and the length of the receiving pockets is preferably rather selected accordingly so as to be slightly longer.

Embodiments are described hereinafter with reference to the accompanying FIGS. 1 to 9.

FIG. 1 shows a fully assembled cable termination device 1, which comprises a termination cap 2 and a screw unit 4. A flat 5 is provided on the screw unit 4. A cable end 13 of a cable 6 is terminated in the cable termination device 1 in an electric-shock-proof manner.

The cable termination device 1 here is constructed of only two plastics parts. The cable termination device 1 comprises a termination cap 2 and a screw unit 4. Only a flexible sealing unit 12 is provided in addition.

The termination cap 2 on the outer end 14 of the cable termination device 1 here is constructed such that it is spherical. A locking device 7 in the form of a groove extending in a transverse direction or a slot 17 extending in a transverse direction is provided on the termination cap 2. A tool such as a screwdriver 23 (cf. FIG. 8), for example, can be inserted into the locking device 7 in order to hold the termination cap 2 tight during the screwing process. The housing 20 of the cable termination device 1 here essentially consists of the termination cap 2 and the screw unit 4, which are screwed together during assembly.

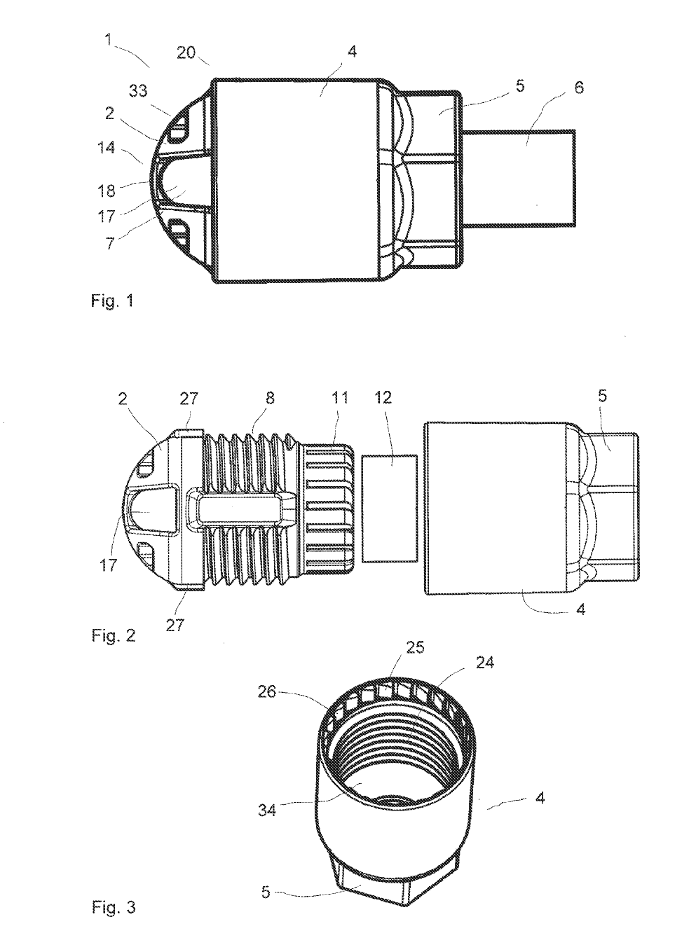

FIG. 2 is an exploded view, in which, in addition to the termination cap 2 and the screw unit 4, the sealing unit 12 is also visible, which seals the cable end of a cable 6 to be connected with respect to the termination cap 2 in the assembled state.

FIG. 3 is a perspective plan view onto the screw unit 4, which has an inner thread 24 here, while the termination cap 2 has an outer thread 8. During assembly the inner thread 24 is screwed onto the outer thread 8 of the termination cap 2.

A latching device 25 is provided on the housing 20 and comprises a latch toothing 26, which is provided here as a radial inner toothing on the screw unit 4, and latching elements 27, which are formed here radially on the outside of the termination cap. The latching device 25 is formed such that it is only possible to continue the screwing process if the latching elements 27 engage in the latch toothing 26. Screwing in the opposite direction in order to release the screw part 4 again is reliably prevented by the latching device 25.

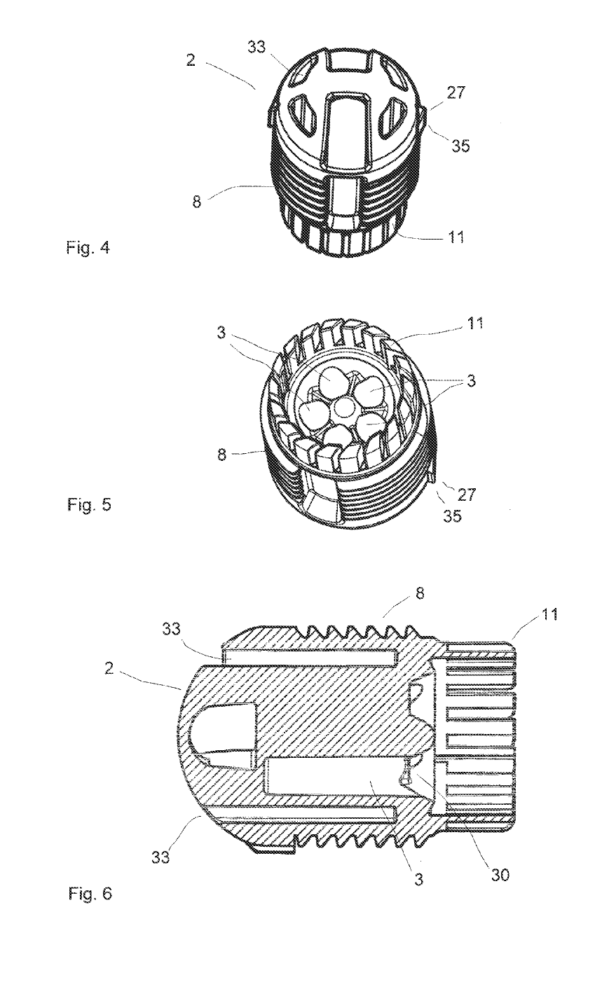

FIG. 4 is a perspective plan view onto the termination cap 2, which clearly shows the two latching elements 27 on opposite sides of the termination cap 2. The latching elements 27 can be constructed such that they are resilient and have a chamfer 35 such that makes it easier to screw into the screw part, while removal is prevented.

Indentations 33 can be provided to increase the resilience. The indentations or recesses 33 also serve to save on materials.

A lamella structure 11 is compressed during the assembly process and presses against the sealing unit 12—not visible here—in order to receive the cable 6 tightly in the termination cap 2.

FIG. 5 is a perspective view of the termination cap 2 from below, the receiving pockets 3 for receiving the individual cores 19 being visible. Here in the embodiment shown, five receiving pockets 3 for receiving five individual cores 19 are provided. It is, however, also possible to provide just one receiving pocket 3 to receive one single core. Depending on the purpose and size, two, three, four or, for example, six or more receiving pockets 3 can also be provided. The number of receiving pockets 3 does not have to be equivalent to the number of individual cores, but can in particular also be greater.

FIG. 6 is a cross section of the termination cap 2 according to FIGS. 4 and 5. Because the receiving pockets 3, of which there are five in this case, are arranged symmetrically over the circumference, only one receiving pocket 3 is visible in the cross section. An insertion sleeve 30 in the form of an insertion chamfer or an insertion funnel can be assigned to the receiving pocket 3 in order to facilitate the insertion of the cores 19 into the receiving pockets 3.

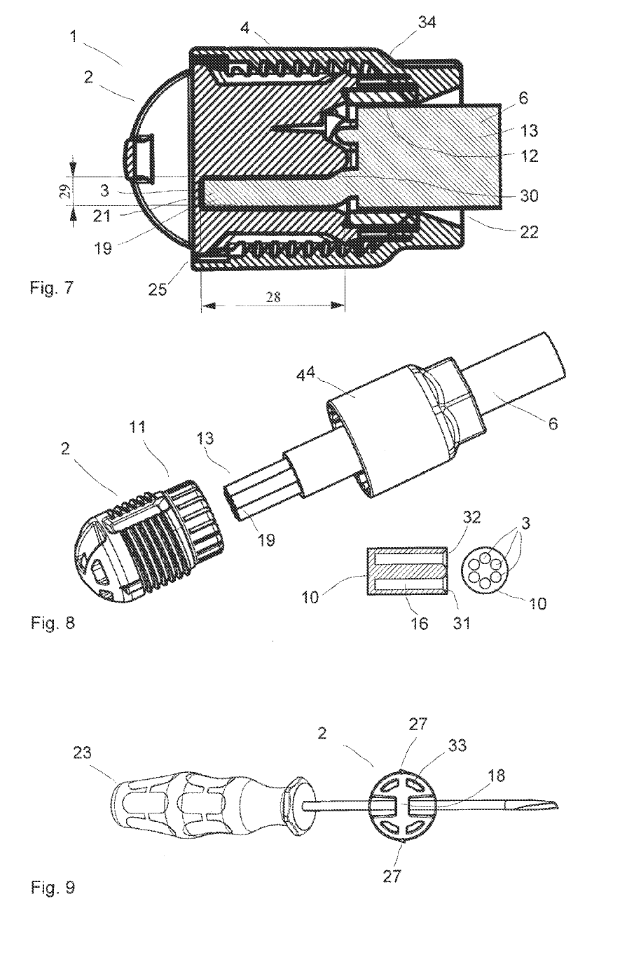

FIG. 7 is a cross section through a cable termination device 1 in the assembled state. The termination cap 2 is screwed to the screw unit 4 such that the latching device 25 prevents a release of the connection.

A core end 21 of a core 19 is inserted into the receiving pocket 3. The length 28 of the receiving pocket 3 is such that an adequate air gap and creepage path is maintained for the intended purpose.

The air gap and creepage path can be double the length 28 of the receiving pocket 3 or slightly greater if the receiving pockets 3 are laterally spaced from one another. The actual air gaps and creepage paths depend on the length of the cores and can thus also be shorter than double the length of the receiving pockets.

The receiving pocket 3 has a diameter 29 that is adjusted to the cores to be received.

During assembly, the sealing cone 34 presses against the sealing unit 12 such that a tight reception of the cable end 13 of the cable 6 is ensured.

The insertion aid 30 in the form of an insertion chamfer can also be seen clearly on the receiving pocket 3.

FIG. 8 is a perspective exploded view of the cable termination device 1 being assembled. A longitudinal portion of the cable sheath corresponding to the length 28 of the receiving pockets or slightly longer has been removed from the cable 6 such that the cores 19 on the cable end 13 are present individually. The screw part 4 has been put onto the cable end 13. Subsequently, the cable end 13 is inserted into the screw part 2, a slight rotation of the screw part in relation to the cable end 13 or of the cable end 13 in relation to the screw part is helpful in order to ensure insertion of the cores 19 into the individual receiving pockets 3 in the termination cap 2.

An alternative embodiment is also outlined in FIG. 8, where an insert 10 is inserted into the termination cap 2. The insert 10 has the desired number of receiving pockets 3. As in the other embodiments too, the receiving pockets 3 are each formed as a blind hole 16. The variant of the insert 10 shown here has six receiving pockets 3. Each receiving pocket has an insertion aid 30, which has insertion chamfers 31, such that the insertion aids are each formed as insertion funnels 32.

Subsequently, a screwdriver, for example, is inserted as a tool 23 into the locking device 7 and the screw part 4 is screwed to the termination cap 2, such that a tight fit of the termination cap on the screw part 4 occurs, which cannot be released again by hand.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE NUMERALS

Cable termination device 1
Termination cap 2
Receiving pocket 3
Screw unit 4
Flat 5
Cable 6
Locking device 7
Outer thread 8
Insert 10
Lamella structure 11
Sealing unit 12
Cable end 13
Outer end 14
Blind hole 16
Slot 17
Web 18
Core 19
Housing 20
Core end 21
Insertion opening 22
Tool 23
Inner thread 24
Latching device 25
Latch toothing 26
Latching element, tooth 27
Length 28
Diameter 29
Insertion aid 30
Insertion chamfer 31
Insertion funnel 32
Indentation 33
Sealing cone 34
Chamfer 35

1. A cable termination device comprising: a housing having a termination cap and a screw unit which interacts with the termination cap, and an insertion opening for a cable having at least one core, in order to terminate an end of the cable in an electric-shock-proof manner, the insertion opening being provided in the screw unit,
wherein at least one elongate receiving pocket is provided in the housing to receive the at least one core.

2. The cable termination device recited in claim 1, wherein the at least one receiving pocket is provided on an insert, which is received at least, in part, inside the termination cap.

3. The cable termination device recited in claim 1, wherein the at least one receiving pocket is formed in the termination cap.

4. The cable termination device recited in claim 1, wherein the at least one receiving pocket is formed as a blind hole.

5. The cable termination device recited in claim 1, wherein a length of the at least one receiving pocket is at least 2 mm.

6. The cable termination device recited in claim 1, wherein a length of the at least one receiving pocket is at least twice as large as a diameter of the receiving pocket.

7. The cable termination device recited in claim 1, wherein an insertion aid is assigned to the at least one receiving pocket.

8. The cable termination device recited in claim 7, wherein the insertion aid is constructed as an insertion chamfer or an insertion funnel.

9. The cable termination device recited in claim 1, wherein at least one latching device is provided for latching the screw unit to the termination cap, and wherein the latching device comprises at least one latch toothing and at least one resilient latch element interacting therewith.

10. The cable termination device recited in claim 9, wherein the at least one latch toothing is provided radially inside the screw unit, and wherein the at least one resilient latch element is provided radially on the outside of the termination cap.

11. The cable termination device recited in claim 9, wherein the latch device comprises at least one helical toothing, the helical toothing engaging at least portions of the latch element when they are screwed together, and wherein the teeth of the helical toothing rise less steeply in the screwing direction than in the opposite direction.

12. The cable termination device recited in claim 1, wherein the termination cap includes at least one of an outer thread along at least one longitudinal portion or wherein the screw unit having an inner thread along at least one longitudinal region.

13. The claim termination device recited in claim 1, wherein at least two receiving pockets are provided.

14. The cable termination device recited in claim 1, wherein the screw unit has a sealing cone, and wherein a lamella structure is compressed when the screw unit is screwed to the termination cap such that the sealing unit is pressed against the inserted cable end.

15. The cable termination device recited in claim 1, wherein a maximum deflection angle of at least one core end of the cable end is less than 75°.

16. The cable termination device of claim 1, wherein an angle between a longitudinal axis of the housing and a longitudinal axis of the at least one receiving pocket is less than 30°.

16. The cable termination device recited in claim 5, wherein the length of the at least one receiving pocket is at least 5 mm.

17. The cable termination device recited in claim 5, wherein the length of the at least one receiving pocket is at least 10 mm.

18. The cable termination device recited in claim 5, wherein the length of the at least one receiving pocket is at least four times as large as the diameter of the receiving pocket.

19. The cable termination device recited in claim 15, wherein a maximum deflection angle of the at least one core end of the cable end is less than 60°.

20. The cable termination device recited in claim 16, wherein the angle between the longitudinal axis of the housing and the longitudinal axis of the at least one receiving pocket is less than 15°.
